(19) United States
(12) Patent Application Publication
(10) Pub. No.: US 2011/0132198 A1
(43) Pub. Date: Jun. 9, 2011

(54) FILTER ASSEMBLY

(75) Inventor: Christopher J. Gallo, North Canton, OH (US)

(73) Assignee: HEAT SURGE, LLC, Canton, OH (US)

(21) Appl. No.: 12/959,895

(22) Filed: Dec. 3, 2010

Related U.S. Application Data
(60) Provisional application No. 61/267,305, filed on Dec. 7, 2009.

(51) Int. Cl. B01D 46/10; B01D 50/00

(52) U.S. Cl. 96/222; 55/484; 55/385.1

(57) ABSTRACT

A filter assembly for filtering a fluid entering an intake of a device. The filter assembly includes a first filter frame that is engaged with the device adjacent the intake, a first filter disposed in the first filter frame, a second filter frame engaged with the first filter frame, and a second filter disposed in the second filter frame. When the filter assembly is positioned on the device, fluid entering the intake is drawn through one or both of the first and second filters.

### CROSS-REFERENCE TO RELATED APPLICATIONS

This application claims priority from U.S. Provisional Application Ser. No. 61/267,305 filed Dec. 7, 2009, the entire specification of which is incorporated herein by reference.

### BACKGROUND OF THE INVENTION

1. Technical Field

The invention relates generally to filter assembly for filtering fluid entering an intake of a device. More particularly, the invention relates to a filter assembly for a heating unit. Specifically, the invention relates to a filter assembly having a first and a second filtration element, with the first filtration element being disposed adjacent the intake on the heating unit and the second filtration element being selectively detachable from the first heating unit as well as permitting independent removal of one or both of the first and second filtration elements.

2. Background Information

Filters are used in a variety of different applications, including in filtering air and liquids in automobiles and home heating and cooling units. A particulate filter is a device which is used to remove particles such as dust, mold, pollen and bacteria from the air. Traditional particulate filters come in a variety of forms including foam, HEPA, pleated, paper, cotton fiber, and other styles. For example, household furnaces require that air entering an intake to the machine be filtered. The filter cannot be provided directly across the intake because access to that location is limited and there is frequently insufficient room adjacent the intake to position the filter. The furnace is therefore provided with ductwork that extends from adjacent the intake to a housing in a remote location therefrom. Any one of the traditional type of particulate filters is inserted across an opening in the housing. A cover is provided to restrict access to the opening and to the filter disposed therein. In order to replace the filter, the user must first remove the protective cover to gain access to the filter. Once the filter has been replaced, the cover is replaced and the furnace can be used once again.

In even more compact quarters it is difficult to provide a housing for a filter and to provide ductwork to connect the housing to the intake. In such instances it is even more difficult to use a second filter to further filter the intake air as even more ductwork needs to be provided to connect a housing for the second filter to the housing for the first filter. In addition, a dual filter setup makes it difficult to remove only one of the two filters it provides necessary to replace them. For example, the inner filter can only be removed by first removing the outer filter thereby making the filter removal cumbersome.

Fragrances are also generally known and used in various applications in homes and automobiles to improve the quality of the air. Fragrances can be provided in a number of forms including plug-in style housings which heat scented oil, candles, or chemicals which are sprayed or evaporated into the air. Specifically, air fresheners are generally localized, meaning that they are only disposed within a single room or within a cabin of a vehicle. Accordingly, a large number of air fresheners may be necessary in order to ensure that the scent is distributed throughout a room or a house.

### BRIEF SUMMARY OF THE INVENTION

The present invention broadly covers a filter assembly for filtering a fluid entering an intake of a device. The filter assembly includes a first filter frame that is engaged with the device adjacent the intake, a first filter disposed in the first filter frame, a second filter frame engaged with the first filter frame, and a second filter disposed in the second filter frame. When the filter assembly is positioned on the device, fluid entering the intake is drawn through one or both of the first and second filters.

### BRIEF DESCRIPTION OF THE SEVERAL VIEWS OF THE DRAWINGS

The preferred embodiment of the invention, illustrative of the best mode in which Applicants have contemplated applying the principles of the invention, is set forth in the following description and is shown in the drawings.

FIG. 1 is a perspective rear view of a preferred embodiment of a filter assembly in accordance with the present invention secured around an air intake of a heating unit;

FIG. 2 is a perspective rear view of the filter assembly of FIG. 1 with the filter assembly removed from the heating unit and illustrating the air intake ports that are surrounded by the filter assembly;

FIG. 3 is a perspective rear view of the filter assembly having both a first filter frame and a second filter frame;

FIG. 4 is an enlarged view of the highlighted region of FIG. 3 and illustrating a coupling device for joining the first filter frame and second filter frame together;

FIG. 5 is a partial cross-sectional side view taken along line 5-5 of FIG. 3 and showing the second filter frame in a first position where it filters air passing therethrough and showing, in phantom, a second position the second filter frame can be removed from the first filter frame;

FIG. 6 is a perspective front view of the filter assembly showing the first filter frame and a portion of the second filter frame attached thereto;

FIG. 7 is an exploded rear perspective view of the filter assembly;

FIG. 8 is a front perspective view of the second filter frame;

FIG. 9 is a perspective view of a scented oil being dispensed on a second filter;

FIG. 10 is a front perspective view of the second filter frame with the second filter located in a cavity therein;

FIG. 11 is a cross-sectional side view illustrating air being directed through the filter assembly, through the air intake and into the heating unit.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred embodiment, it is to be understood that the invention as claimed is not limited to the disclosed aspects.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

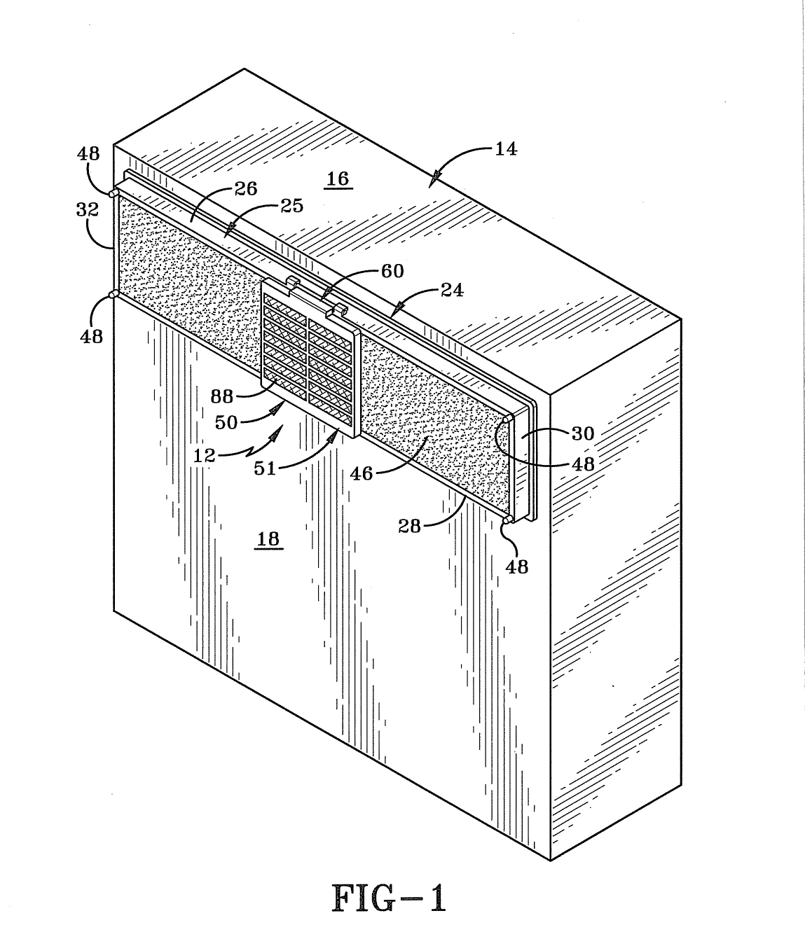

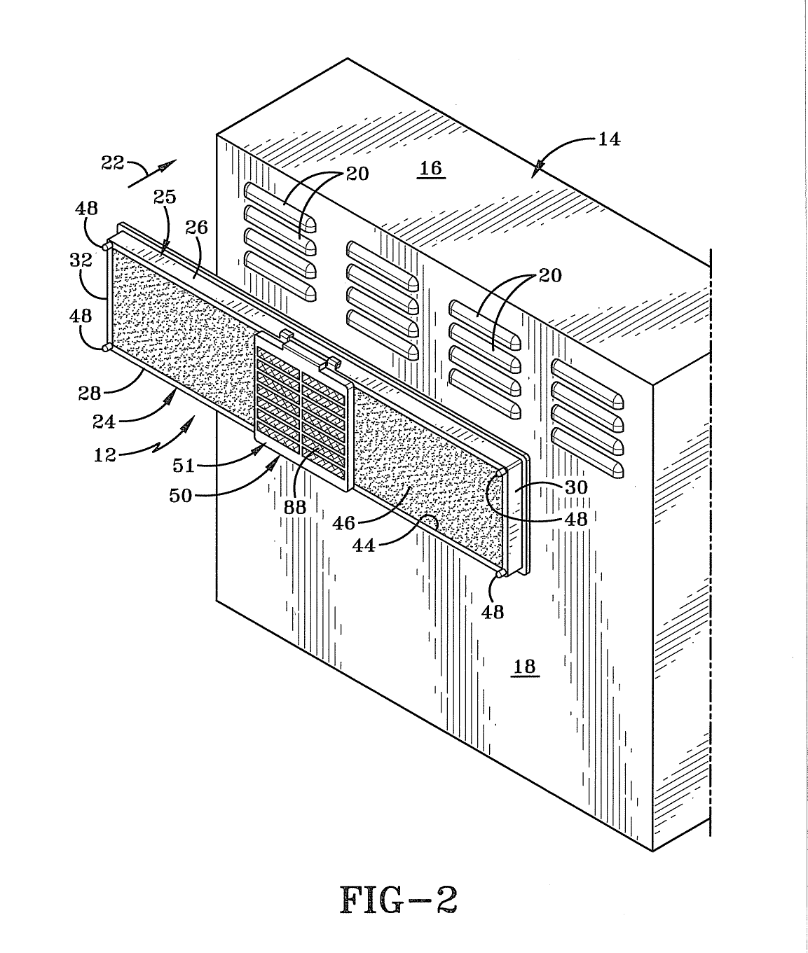

The filter assembly of the present invention is indicated generally at 12, and is shown in FIGS. 1 through 11. As particularly shown in FIGS. 1 and 2, the filter assembly 12 is secured to a heating unit 14. Heating unit 14 includes at least a top wall 16 and a back wall 18. Back wall 18 includes a plurality of intake ports 20 which take in ambient air into heating unit 14. Heating unit 14 heats up that air and then releases the heated air through the outlets, which are not shown herein While heating unit 14 is shown having intake ports 20 located on back wall 18, intake ports 20 could also be located on top wall 16 as well as any other walls of the heating unit. FIG. 2 also illustrates filter assembly 12 separated from heating unit 14, and includes arrow 22 representing the direction in which filter assembly 12 is moved in order to install the filter assembly on heating unit 14 and around intake ports 20 thereof.

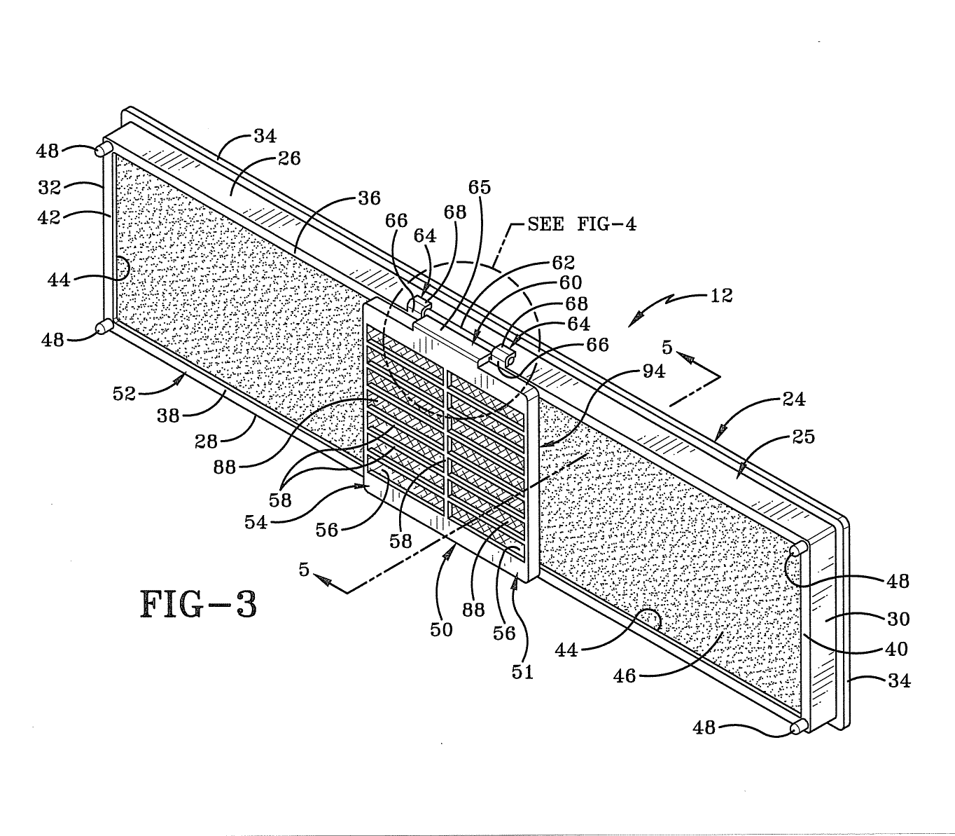

Referring to FIG. 3, filter assembly 12 includes a primary filter assembly 24 and a secondary filter assembly 50 that are secured to each other by a coupling member 60. Primary filter assembly 24 comprises a first filter frame 25 and a first filter 46. First filter frame has a top wall 26, a bottom wall 28, a first side wall 30, and a second side wall 32. First filter frame 25 also preferably includes an L-shaped ridge 34 integrally formed with top wall 26, bottom wall 28, first side wall 30, and second side wall 32. Ridge 34 preferably extends perpendicularly from each of the top wall, bottom wall, and first and second side walls and thereby increases the overall external size of filter assembly 12. Top, bottom, first and second side walls 26, 28, 30 & 32 bound and define an interior chamber 44. First filter 46 is complementary sized and shaped to be received in chamber 44. While first filter 46 preferably is a charcoal style filter, it is within the spirit and scope of the present invention to utilize a HEPA filter, a pleated style filter, or any other suitable filter in filter assembly 12.

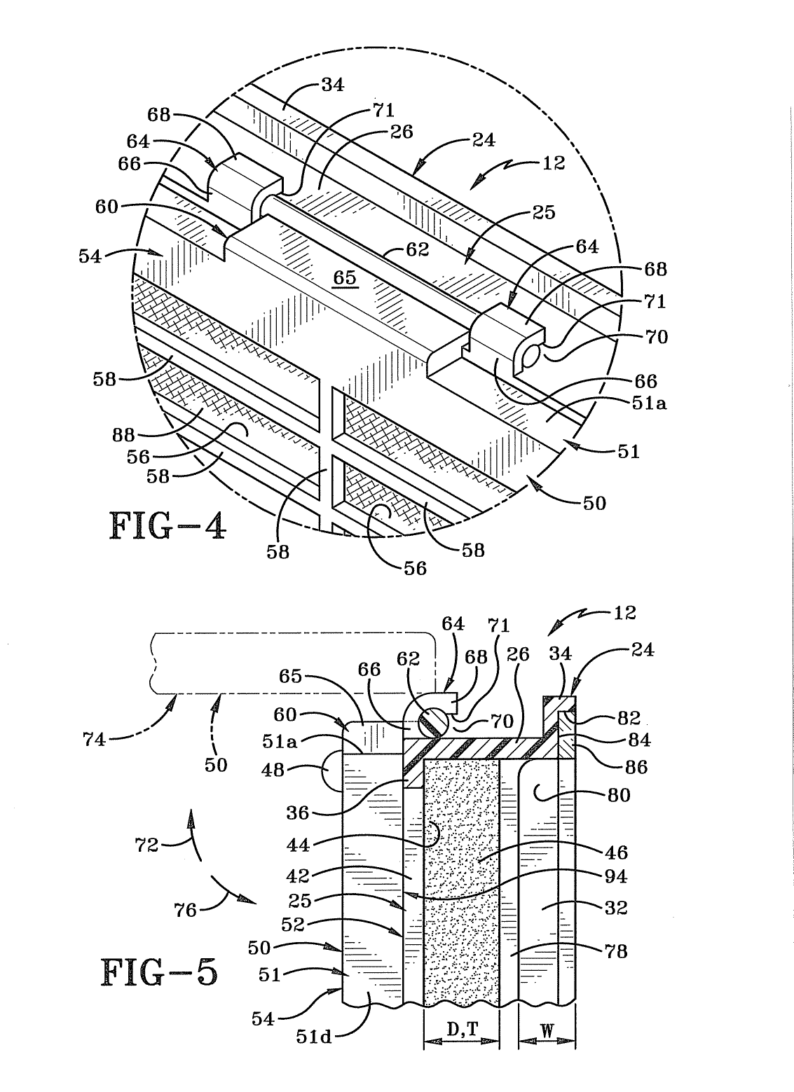

In accordance with a feature of the present invention, a mounting slot 82 (FIGS. 5 & 6) is defined by ridge 34 and a back region 84 of each of the top, bottom, first and second side walls 26, 28, 30, and 32. A mount 86 is permanently held within mounting slot 82. Mount 86 may be a magnet, a hook and loop fastener, a resealable tape, a non-residue adhesive, or any other suitable fastener that will retain filter assembly 12 in engagement with back wall 18 of heating unit 14 as will be further described herein. Ridge 34 and mount 86 constitute a front face of primary filter assembly 24 that is placed in abutting contact with back wall 18.

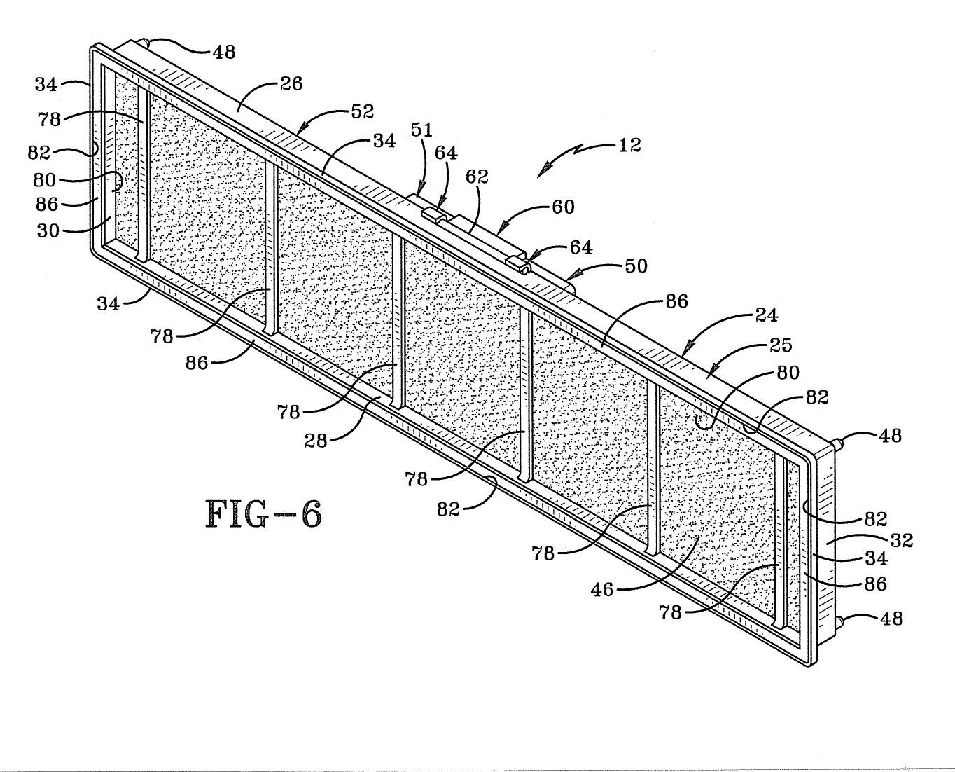

FIG. 6 illustrates a front perspective view of filter assembly 12 showing a plurality of ribs 78 extending from top wall 26 to bottom wall 28 of first filter frame 25. While ribs 78 are shown and described as running from top wall 26 to bottom wall 28, it is within the spirit and scope of the present invention to arrange ribs 78 to extend from first side wall 30 to second side wall 32. Furthermore, although six ribs are utilized in the preferred embodiment, any suitable number of ribs 78 may be used, so long as first filter 46 is held in place by the ribs. As shown in FIG. 5, ribs 78 preferably are offset from ridge 34 a distance “W”. This offset creates an intake passage 80 within which intake ports 20 from heating unit 14 will fit when first filter frame 25 is engaged with back wall 18. This arrangement permits ridge 34 and mount 86 to rest flush against heating unit 14 while still allowing intake ports 20 to be surrounded by filter assembly 12.

First filter frame 25 further includes an upper containment wall 36 extending perpendicular to top wall 26 and opposite ridge 34. Similarly, bottom wall 28 includes a bottom containment wall 38, while first side wall 30 includes a containment wall 40, and second side wall 32 includes a containment wall 42. Containment walls 36, 38, 40 and 42 extend in direction opposite to ridge 34 relative to top wall 26. Consequently, containment walls 36, 38, 40, 42 reduce the outer perimeter of internal chamber 44. First filter 46 is retained in chamber 44 between ribs 78 and containment walls 36, 38, 40, 42. Furthermore, containment walls 36, 38, 40, 42 comprise a rear face 52 of primary filter assembly 24. FIGS. 5 & 7 show that chamber 44 has a depth “D” and that first filter 46 has a thickness “T” which also approximately corresponds to internal chamber depth “D”.

First filter frame 25 also includes a plurality of spacers 48 preferably arranged about the periphery of rear face 52 and extending outwardly and rearwardly therefrom. Spacers 48 are provided to create a gap between the rear face of first filter frame 25 and an object against which heating unit 14 may rest. Inasmuch as secondary filter assembly 50 is connected to primary filter assembly 24, spacers 48 are longer than secondary filter assembly 50 is deep. Advantageously, spacers 48 ensure that a sufficiently large enough gap is created between an object and secondary filter assembly 50 so that ambient air can be drawn into intake ports 20. This arrangement permits heating unit 14 to be backed against a wall or other surface and still ensure that the heating unit can take air into the intake ports 20.

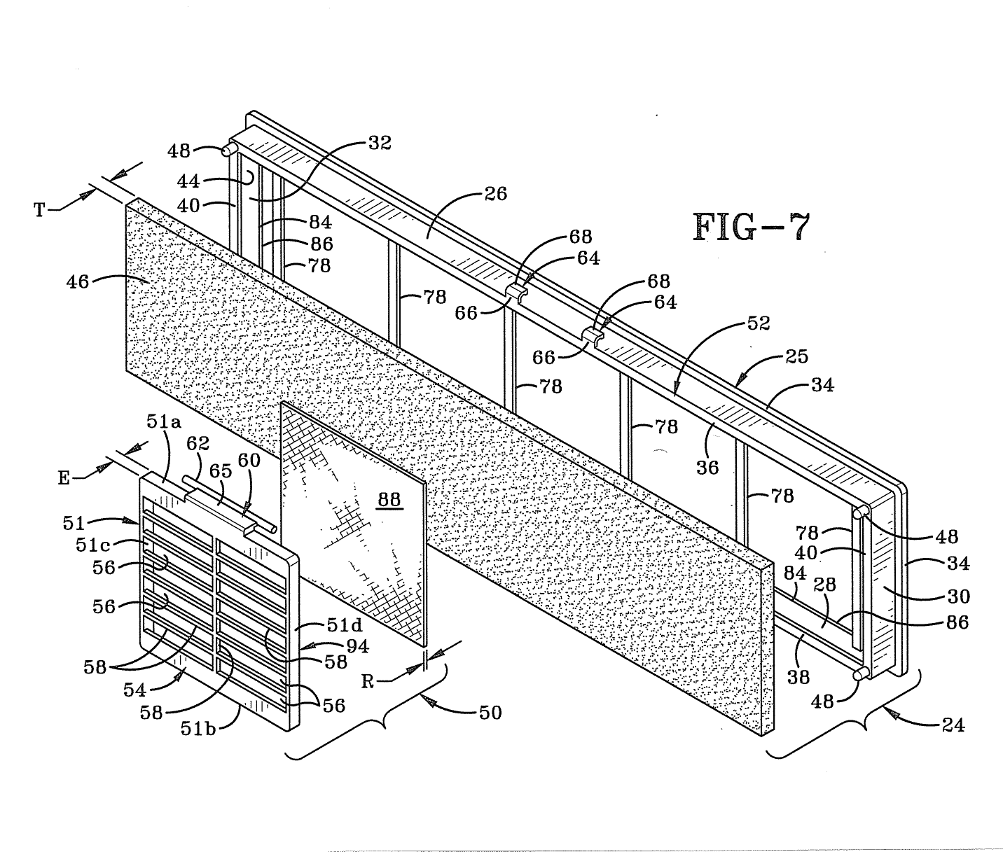

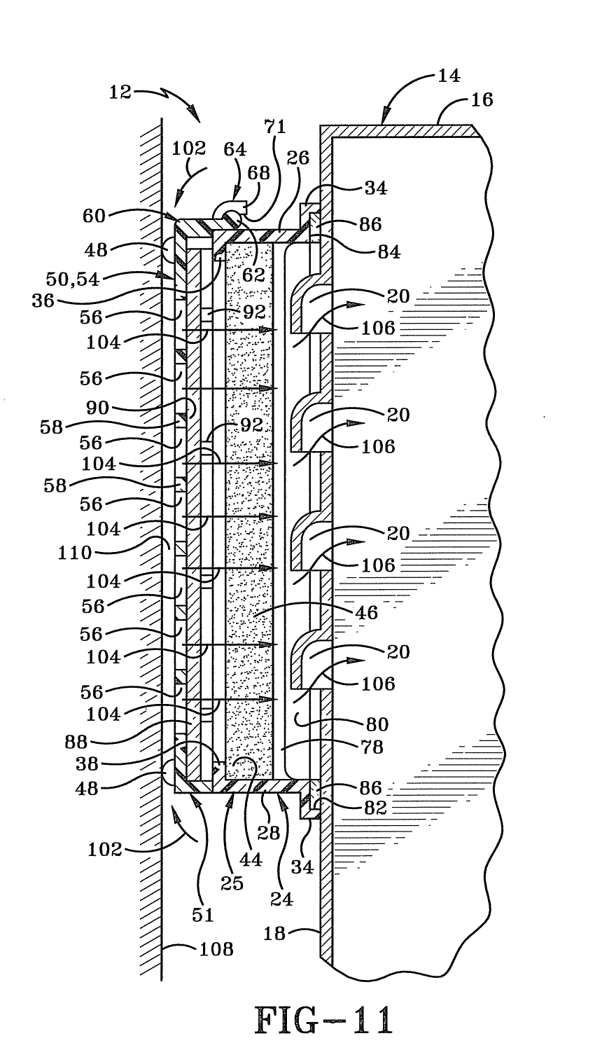

Referring to FIGS. 3 and 4 and in accordance with still another feature of the present invention, filter assembly 12 includes a secondary filter assembly 50. Secondary filter assembly 50 includes a second filter frame 51 and a second filter 88. Second filter frame 51 is attached to first filter frame 25 by coupling member 60. Second filter frame 51 has a top wall 51a, a bottom wall 51b, a first side wall 51c, and a second side wall 51d. Top, bottom first and second side walls 51a-51d bound and define an interior cavity 90 (FIG. 8) in which second filter 88 is retained. Second filter frame 51 further includes a rear face 54 in which are provided a number of dividers 58 that are separated from each other by openings 56. A plurality of tabs 92 are preferably located along the perimeter of a front region 94 of second filter frame 51 and second filter 88 is retained within cavity 90 between tabs 92 and dividers 58 (FIG. 10). Second filter 88 has a thickness “R” (FIG. 7) that is smaller than a depth “E” of cavity 90. In the preferred embodiment, second filter 88 preferably is made from a denser material than is first filter 46 and may be composed of dense cotton or any other suitable material that is capable of absorbing a liquid while still permitting air to pass through it. During operation, second filter 88 is disposed proximate first filter 46 (FIG. 11) as will be hereinafter described.

In accordance with yet another specific feature of the present invention, filter assembly 12 further includes coupling member 60 which secures primary filter assembly 24 and secondary filter assembly 50 together. Preferably, coupling member 60 is disposed so as to secure top wall 26 of first filter frame 25 to top wall 51a of second filter frame 51. It will, of course, be understood that primary and secondary filter assemblies 24, 50 could be secured together in locations that correspond to each other. Coupling member 60 comprises a retainer 64 and a pivot rod 62. Retainer 64 is provided on top wall 26 of first filter frame 25. Retainer 64 includes a pair of spacing arms 66 that extend upwardly and perpendicularly from top wall 26. A locking arm 68 extends forwardly and perpendicularly from a top end of each spacing arm 66. Referring specifically to FIGS. 4 and 5, it can be seen that spacing arms 66 and locking arms 68 form the generally L-shaped retainer 64. Further, an aperture 70 is defined between each spacing arm 66, locking arm 68, and top wall 26.

Pivot rod 62 is provided on top wall 51a of second filter frame 51. Pivot rod 64 extends outwardly and forwardly from a base 65 (FIG. 4) that is provided on top wall 51a. Pivot rod 64 extends beyond the front face 94 of second filter frame 51 and is disposed generally parallel to said front face 94. Pivot rod 62 is removably received within aperture 70 and thereby removably secures first filter frame 25 to second filter frame 51. A locking detent 71 preferably extends downwardly from an interior surface of locking arm 68 and toward top wall 26 to further secure pivot rod 62 within aperture 70.

When first and second filter frames 25, 51 are secured together by coupling member 60, second filter frame 51 is pivotable about pivot rod 62 between a first position and a second position. In the first position, shown in FIG. 1, second filter frame 51 is disposed substantially parallel to first filter frame 25 and is in an active position for filtering air flowing into intake ports 20. When in this first position, air must flow through both of second filter 88 and first filter 46. This orientation is illustrated in cross-section in FIG. 11. In this first position, neither of the first filter 46 and the second filter 88 can be removed from their respective first and second filter frames 25, 51.

FIG. 5 shows that second filter frame 51 is pivotable about pivot rod 62 to a second position. This second position is illustrated in phantom in FIG. 5. In this second position, air flowing into intake ports 20 will only travel through first filter 46. Additionally, when second filter frame 51 is in this second position, both of the first filter 46 and second filter 88 may be removed from their respective frames and may be replaced with new first and second filters. It is only when second filter frame 51 has been rotated through at least 90° relative to the rear face 52 of first filter frame 25 that both of the first and second filters 46, 88 can be removed with ease. Consequently, in order to replace first and second filters 46, 88, second filter frame 51 must be rotated in the direction associated with arrow 72 (FIG. 5) until the second filter frame 51 is approximately perpendicular to rear face 52 or is at an angle of greater than 90° relative thereto. This is illustrated in FIG. 5 as position 74.

Advantageously, secondary filter assembly 50 is not removable from primary filter assembly 24 when rotated in the direction associated with arrow 76 less than the perpendicular position. Thus, secondary filter 88 can be removed if the second filter frame 51 is rotated at least approximately ninety degrees in the direction associated with arrow 72, but cannot be removed if frame 51 is rotated less than ninety degrees. Beneficially, this arrangement allows pivot rod 62 to freely pivot within aperture 70 but still remain secured to first filter frame 25 during any such movement.

Second filter frame 51 may also be completely detached from first filter frame 25. This is accomplished by rotating second filter frame 51 until it is at least perpendicular to the rear face of first filter frame 25 and then simply pushing second filter frame 51 forwardly toward heating unit 14. This motion will slide pivot rod 62 out of aperture 70 in coupling member 60. Second filter frame 51 may be attached to first filter frame 25 by reversing these steps.

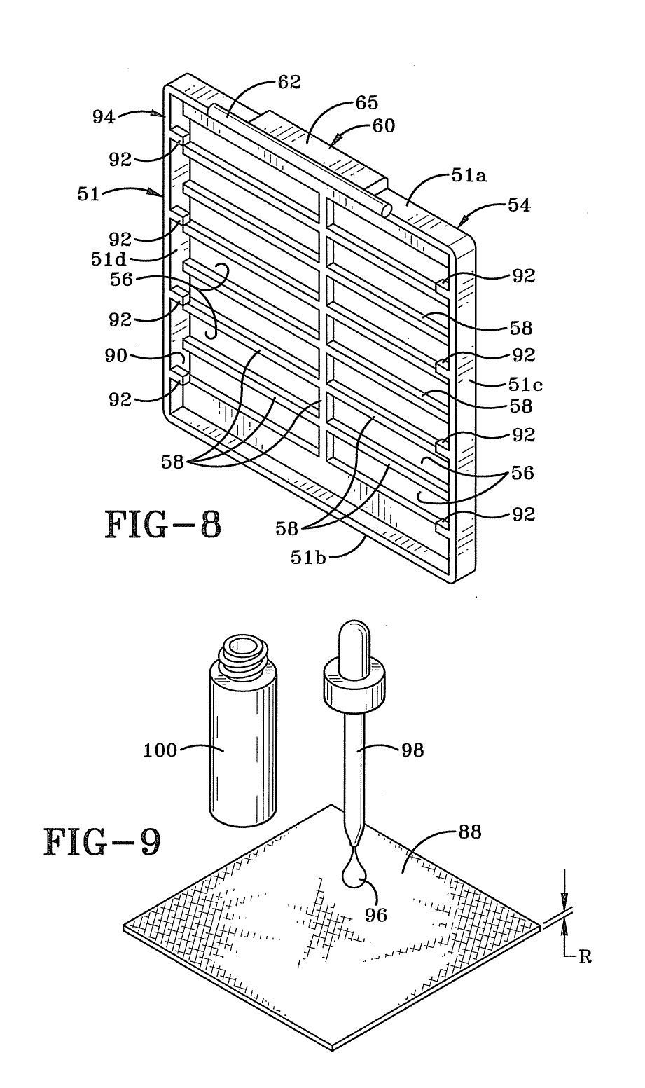

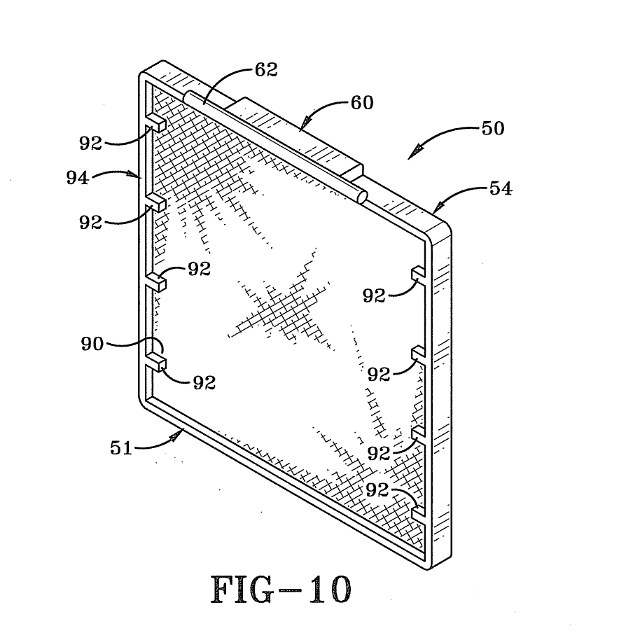

In accordance with an aspect of the present invention, filter assembly 12 may be used to disseminate a fragrance into a room through heating unit 14. Referring to FIGS. 9 and 10, a scented oil or fragrance 96 is dispensed from a dropper 98 of bottle 100 and onto second filter 88 when removed from second filter frame 51. The user can select the intensity of the fragrance by controlling how much oil 96 is placed on second filter 88. After dispensing oil 96 on second filter 88, second filter 88 is inserted into cavity 90 between tabs 92 and dividers 58. Second filter frame 51 is rotated back into the first position so that air drawn through the same will pick up the scent as it evaporates from second filter 88. When the heating unit 14 heats up that now-scented air and blows it outwardly through the outlets (not shown), the scent is distributed throughout the room in which heating unit 14 is positioned. Furthermore, because second filter 88 is separate from first filter 46, the user can exchange one second filter 88 having a first scent thereon for a second filter 88 with a second scent thereon. This allows the user to customize both the scent and potency of the scent as he or she desires.

In accordance with yet another feature of the present invention and referring to FIG. 11, filter assembly 12 is removably secured to heating unit 14 by mount 86. Furthermore, when heating unit 14 is located near a wall 108 or another object, spacers 48 contact wall 108 and define a space 110 between first filter frame 25 and the wall. Advantageously, spacers 48 ensure that ambient air 102 can be directed through first filter 46 and second filter 88. In operation, ambient air 102 enters second filter 88, then flows into first filter 46 as indicated by arrows 104 and ultimately into intake ports 20 of heating until 14 as indicated by arrows 106. Furthermore, due to the fact that second filter frame 51 is not necessarily of the same overall dimensions as first filter frame 25, at least some of the ambient air 102 may pass directly through first filter 46 and into intake ports 20, bypassing second filter 88 altogether. It will be understood, however, that second filter frame 51 may be made to be of the same dimensions as first filter frame 25 and that more than one coupling member 60 may be provided to secure the two filter frames together.

Thus, filter assembly 12 provides air filtration and is also easily removable to replace the dual filters. The filter assembly 12 may also incorporate a second filter which is provided with a user-selected scent. Further, the second filter frame 51 is pivotably coupled with the first filter frame 25 and the second filter 88 and first filter 46 are only removable when the second filter frame 51 is pivoted approximately ninety degrees or more relative to first filter frame 25

It will be evident to one skilled in the art that a variety of changes can be made that are within the spirit and scope of the present invention. For instance, the second filter can be configured integral to the first filter and remedy the need for the second filter frame. The second filter frame can also be shaped and sized similar to first filter 46 to increase the scent effect. Further, the coupling member 60 between the first filter frame 25 and second filter frame 51 may be modified so long as the second filter frame still permits removal of first filter 46 from chamber 44 as well as second filter 88 from cavity 90 without having to disassemble the entire filter assembly 12.

Accordingly, the filter assembly is an effective, safe, inexpensive, and efficient device that achieves all the enumerated objectives of the invention, provides for eliminating difficulties encountered with prior art devices, systems, and methods, and solves problems and obtains new results in the art.

It will be understood that while the preferred embodiment of the invention is described specifically as being directed to an air filter assembly, the assembly could be used for filtering other fluids. So, for example, the filter assembly of the present invention could be used in applications double filtration of a liquid is required.

In the foregoing description, certain terms have been used for brevity, clearness, and understanding; but no unnecessary limitations are to be implied there from beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries, and principles of the invention, the manner in which the filter assembly is constructed and used, the characteristics of the construction, and the advantageous new and useful results obtained; the new and useful structures, devices, elements, arrangement, parts, and combinations are set forth in the appended claims.

1. A filter assembly for filtering a fluid entering an intake of a device, said filter assembly comprising:
a first filter frame adapted to be engaged with the device adjacent the intake;
a first filter disposed in the first filter frame;
a second filter frame engaged with the first filter frame; and
a second filter disposed in the second filter frame; and wherein fluid entering the intake is drawn through one or both of the first and second filters.

2. The filter assembly as defined in claim 1, wherein said first filter frame has a front face and a rear face and the front face is adapted to be disposed proximate the intake; and wherein the second filter frame has a front face and a rear face, and the front face of the second filter frame is disposed adjacent the rear face of the first filter frame.

3. The filter assembly as defined in claim 2, further comprising a coupling assembly, and wherein the coupling assembly engages the second filter frame to the first filter frame.

4. The filter assembly as defined in claim 3, wherein the coupling assembly includes a pivot, and the second filter frame is connected to the first filter frame such that it is able to rotate about the pivot.

5. The filter assembly as defined in claim 4, wherein the second filter frame is pivotable between a first position where the front face of the second filter frame is disposed adjacent the rear face of the first filter frame, and a second position where the front face of the second filter frame is disposed at least at 90° relative to the rear face of the first filter frame.

6. The filter assembly as defined in claim 5, wherein neither of the first and the second filters can be removed from the filter assembly if the second filter frame is rotated to a position where it is disposed less than 90° relative to the rear face of the first filter frame.

7. The filter assembly as defined in claim 5, wherein the first filter is removable from the first filter frame and the second filter is removable from the second filter frame only when the second filter frame is in the second position.

8. The filter assembly as defined in claim 6, wherein the first filter is removable from the first filter frame without requiring that the second filter be removed from the second filter frame.

9. The filter assembly as defined in claim 1, wherein the second filter frame is removably engaged with the first filter frame.

10. The filter assembly as defined in claim 1, further comprising a scent, and wherein the scent is applied to one or both of the first and second filters.

11. The filter assembly as defined in claim 10, wherein the scent is applied to the second filter.

12. The filter assembly as defined in claim 11, further comprising a third filter and a second scent applied to the third filter, and wherein the third filter is insertable into the second filter frame once the second filter has been removed therefrom.

13. The filter assembly as defined in claim 1, further comprising a mount, said mount being applied to the front face of the first filter frame, and wherein the mount is adapted to secure the first filter frame to a device so that the first filter frame surrounds the intake thereto.

14. The filter assembly as defined in claim 13, wherein the mount is one of a magnet, a hook and loop fastener, a re-sealable tape, and a non-residue adhesive fastener.

15. In combination:
a heating unit having an external wall;
an air intake provided on the external wall; and
an air filter assembly comprising:
a first filter frame engageable with the external wall so as to surround the air intake;
a first filter disposed in the first filter frame;
a second filter frame engaged with the first filter frame; and
a second filter disposed in the second filter frame; and wherein air entering the intake is drawn through one or both of the first and second filters.

16. The combination as defined in claim 15, wherein the first filter frame has a front face and a rear face, and the front face is disposed proximate the external wall of the heating unit; and wherein the second filter frame has a front face and a rear face, and the front face of the second filter frame is disposed adjacent the rear face of the first filter frame.

17. The combination of claim 16, further comprising a coupling assembly that releasably couples the second filter frame with the first filter frame.

18. The combination of claim 16, wherein the second filter frame is pivotable with respect to the first filter frame.

19. The combination of claim 18, wherein the second filter frame movable between a first pivot position where a front face of the second filter frame is in abutting contact with a rear face of the first filter frame, and a second pivot position where the front face of the second filter frame is spaced a distance from the rear face of the first filter frame and is disposed at an angle relative thereto.

20. The combination of claim 19, wherein the second filter frame is removable from the first filter frame only when in the second position.

21. The combination of claim 20, wherein the angle at which the second filter frame is disposed relative to the first filter frame when it can be removed is an angle of greater than 90°.
